(19) United States
(12) Patent Application Publication
(10) Pub. No.: US 2015/0229747 A1
(43) Pub. Date: Aug. 13, 2015

(54) INTEGRATED SMARTPHONE LIGHT ACCESSORY

(71) Applicant: Coreyn Goddard, Jamaica, NY (US)

(72) Inventor: Coreyn Goddard, Jamaica, NY (US)

(21) Appl. No.: 14/178,512

(22) Filed: Feb. 12, 2014

(51) Int. Cl. H04M 1/22; F21V 13/04; H04M 1/02; F21V 23/04; F21V 23/00; F21V 33/00; F21L 4/00

(52) U.S. Cl. CPC H04M 1/22; F21V 33/0052; F21V 13/045; F21L 4/00; F21V 23/0414; F21V 23/002; H04M 1/026; F21Y 2101/02

(57) ABSTRACT

An integrated smartphone light accessory for enabling the screen of a smartphone to be viewed in the presence of substantially any amount ambient light, including direct sunlight comprises four high capacity LED light assemblies disposed on the frame of a smartphone around the screen. Each LED light assembly is configured as conventional LED, but additionally includes an attached power source, a switch for manually activating the LED light, and an external adhesive for fastening the LED light assembly to the smartphone. The LED light assemblies are operated in pairs, whereby actuation of the switch on one LED light assembly causes that LED light assembly and a second LED light assembly to illuminate or turn off if it was illuminated when the switch was actuated. In use, the high capacity lighting elements in the LED light assemblies are directed towards the screen and enable the screen to be viewed.

### BACKGROUND OF THE INVENTION

1. Field of the Invention

This invention relates generally to mobile electronic device accessories and, more particularly, to a light accessory which enhances viewing of the screen of a mobile electronic device in direct sunlight.

2. Description of the Prior Art

The use of mobile electronic devices (or mobile computers), such as smartphones or tablet computers, is well known. Such devices typically utilize a display screen, such as a touch screen as a user interface for visual output and for manual input. Such screens customarily utilize display technology which provides its own light source, thereby enabling the screen to be easily viewed in many lighting scenarios ranging from complete darkness to fully lit rooms. A problem which still exists, however, is that the display screens on smartphones (or tablets) are typically very difficult to view in environments which include direct sunlight. Indeed, when in direct sunlight, smartphone screens in conventional configurations are often impossible to properly see. As the screen in such a device is often provides both the manual input and output, such a sunny environment often renders the device unusable. Thus, there remains a need for an integrated smartphone light accessory which would allow the screen of a smart phone to be viewable even in direct sunlight. It would be helpful if such an integrated smartphone light accessory employed a high capacity light emitting diode (“LED”) located within the phone to offset the light from the sun. It would be additionally desirable for such an integrated smartphone light accessory to be selectively deployed when desired by a user through a physical, manual actuator.

The Applicant's invention described herein provides for a smartphone light accessory adapted to be integrated on a smartphone, enabling use while in direct sunlight. The primary components of Applicant's integrated smartphone light accessory are an LED assembly defined by a lens, reflector, substrate, submount, junction, and chip. When in operation, the integrated smartphone light accessory allows light from a high capacity LED to be directed towards the screen of a smartphone to enable the screen to be viewed in sunlight. As a result, many of the limitations imposed by the screen configurations of the prior art are removed.

### SUMMARY OF THE INVENTION

An integrated smartphone light accessory for enabling the screen of a smartphone to be viewed in the presence of substantially any amount ambient light, including direct sunlight. The integrated smartphone light accessory comprises four high capacity LED light assemblies disposed on the frame of a smartphone around the screen. While each LED light assembly is configured in a similar manner as conventional LED, the LED light assemblies of the present invention additionally includes an attached power source, a switch for manually activating the LED light, and an external adhesive for fastening the LED light assembly to the smartphone. The LED light assemblies are configured to be operated in pairs, whereby actuation of the switch on one LED light assembly causes that LED light assembly and a second LED light assembly to illuminate or turn off if it was illuminated when the switch was actuated. Because the high capacity lighting elements in the LED light assemblies are directed towards the screen, when illuminated, they provide sufficient illumination to counteract glare from ambient lighting sources, such as the sun, enabling the screen to be viewed.

It is an object of this invention to provide an integrated smartphone light accessory which would allow the screen of a smart phone to be viewable even in direct sunlight.

It is another object of this invention to provide an integrated smartphone light accessory which employs a high capacity LED located within the phone to offset the light from the sun.

It is yet another object of this invention to provide an integrated smartphone light accessory able to be selectively deployed when desired by a user through a physical, manual actuator.

These and other objects will be apparent to one of skill in the art.

### BRIEF DESCRIPTION OF THE DRAWINGS

FIG. 1 is a top plan view of a cross section of an integrated smartphone light accessory built in accordance with the present invention.

FIG. 2 is a top plan view of an integrated smartphone light accessory built in accordance with the present invention mounted on a smartphone.

### DETAILED DESCRIPTION OF THE INVENTION

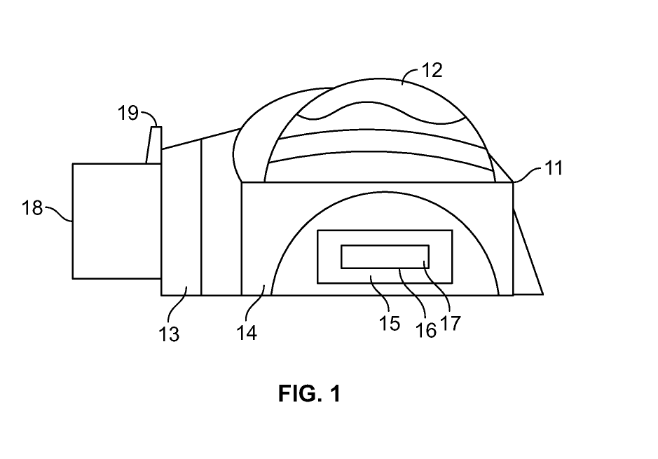

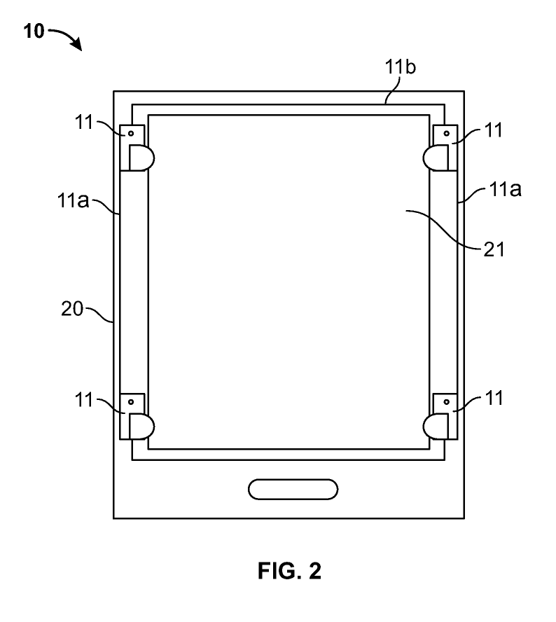

Referring now to the drawings and in particular FIGS. 1 and 2, an integrated smartphone light accessory 10 is shown as four high capacity LED light assemblies 11 disposed on a smartphone 20. Each LED light assembly 11 is configured in a similar manner as conventional LED lights and includes a lens 12, a substrate 13, a reflector 14, a submount 15, a junction 16, and a chip 17. It is appreciated that the lens 12, substrate 13, reflector 14, submount 15, junction 16, and chip 17 are configured in a conventional manner as customary in LED light assemblies. Each LED light assembly 11 additionally includes an attached power source 18, defined as a battery, and a switch 19, which enables the selective provision of electrical power to the LED light assembly 11, which causes it to illuminate, through manual actuation.

Referring now to FIG. 2, a smartphone 20 is shown with the integrated smartphone light assembly 10 of the present invention. In the preferred embodiment, the smartphone 20 with the integrated smartphone light assembly 10 is defined by four high capacity LED light assemblies 11 mounted on the smartphone 20 in the area surrounding the screen 21 of the smartphone 20. It is contemplated that each high capacity LED light assembly 11 is attached to the frame of the smartphone 20 independently, through an adhesive. Despite being mounted individually, each high capacity LED light assembly 11 are connected through an electrical connection wire 11a in one corresponding high capacity LED light assembly 11 which is located at a distinct point around the screen 21. This electrical connection allows the connected high capacity LED light assemblies 11 to be operated in concert, enabling both to be turned on and off by actuating the switch on either one. Consequently, two LED light assemblies 11 can be selectively illuminated (or turned off through actuation of the switch on one LED light assembly 11.

When the LED light assemblies 11 are illuminated, the high capacity lighting element is directed towards the screen 21 and provides sufficient illumination to counteract glare from ambient lighting sources, such as the sun, enabling the screen 21 to be viewed.

In an alternate embodiment, a second electrical connection wire 11b is provided to connect all four high capacity LED light assemblies 11 and enable them to be operated in concert through the actuation of the switch on any one LED light assembly 11.

The instant invention has been shown and described herein in what is considered to be the most practical and preferred embodiment. It is recognized, however, that departures may be made therefrom within the scope of the invention and that obvious modifications will occur to a person skilled in the art.

1. An integrated smartphone light accessory, comprising:
a plurality of discrete LED light assemblies mounted on the frame of a mobile electronic device surrounding the screen, wherein each LED light assembly is defined as a high capacity LED light having its own separate lens, a substrate, a reflector, a submount, a junction, a chip, a power source, and a switch;
wherein each LED light assembly is attached in a separate location to said frame through an adhesive and arranged on said mobile electronic device to enable light emitted therefrom to be directed towards the screen of the mobile electronic device; and
at least one connecting wire, wherein said at least one connecting wire electrically connects two LED light assemblies and enables the connected LED light assemblies to both be illuminated or turned off through actuation of the switch on either connected LED light assembly.

2. The integrated smartphone light accessory of claim 1, wherein:
four LED light assemblies are mounted on the frame of the mobile electronic device; and
a first connecting wire connects a first and a third LED light assembly and a second connecting wire connects a second and a fourth LED light assembly.

3. The integrated smartphone light accessory of claim 2, wherein a third connecting wire connects a second and a third LED light assembly, enabling the first LED light assembly, second LED light assembly, third LED light assembly, and fourth LED light assembly to all be illuminated or turned off through actuation of the switch on either connected LED light assembly.
